(19) United States
(12) Patent Application Publication
(10) Pub. No.: US 2022/0331921 A1
(43) Pub. Date: Oct. 20, 2022

(54) STRUCTURAL COMPONENT FOR A MACHINE TOOL AND METHOD FOR PRODUCING SAME

(71) Applicant: Schneeberger Mineralgusstechnik s.r.o., Cheb - Dolni Dvory (CZ)

(72) Inventors: George BLAHA, Bad Bellingen (DE); Radek PIKRT, Chodov (CZ); Josef MAYR, Zuerich (CH); Eduard RELEA, Maennedorf (CH); Lukas WEISS, Pfaeffikon ZH (CH)

(73) Assignee: Schneeberger Mineralgusstechnik s.r.o., Cheb - Dolni Dvory (CZ)

(21) Appl. No.: 17/642,336

(22) PCT Filed: Sep. 11, 2020
(86) PCT No.: PCT/EP2020/075557

§ 371 Date: Mar. 11, 2022

(30) Foreign Application Priority Data
Sep. 13, 2019 (EP) 19197211.6

(51) Int. Cl. B23Q 11/00; B23Q 1/01

(52) U.S. Cl. CPC B23Q 11/0028; B23Q 1/015; B23Q 11/0007

(57) ABSTRACT

A structural component for a machine tool is formed from a mineral casting and at least one sensor module is integrated into the structural component, wherein the sensor module is completely enclosed by the mineral casting and contains at least one sensor for detecting a mechanical load of the structural component during operation of the machine tool.

The present invention relates to a structural component for a machine tool and to a method of producing such a structural component, as well as to a machine tool having such a structural component and the use of such a structural component in a machine tool and a machine which has to absorb dynamic stress and this stress is to be detected.

Machine tools and processing machines are used in a wide variety of industries, such as mechanical manufacturing, semiconductor industry, SEMI pick-and-place machines, medical technology, automation, or electronics. A machine tool generally comprises a machine structure, which is usually fixed or stationary and is also referred to below as a structural component. The structural component is used for the defined positioning of the object to be machined in relation to the machining device and can be designed, for example, as a machine bed, column, gantry, spindle suspension, device body, etc.

An example of such a machining device is a machine tool with a structural component designed as a machine bed, at or on which the workpiece to be machined is positioned in order to machine it using a tool of the machine tool. A Tool Center Point (TCP for short) is designated as the reference point for the interaction between the tool and the workpiece.

Thermal effects and mechanical loads that occur during operation of the machine tool or can be caused by influences external to the machine can result in geometric changes, in particular dimensional changes of the machine bed. This can have a negative effect on the operation of the machine tool, in particular worsening the precision of workpiece machining, for example by displacing the Tool Center Point from its desired position. As a rule, the machine bed is therefore dimensioned to be sufficiently large and rigid to absorb mechanical loads, whereas thermally induced effects can only be compensated or controlled with difficulties or at great expense.

CN 108422208 A describes a machine bed made of mineral casting with tubes of a cooling system integrated in the mineral casting. A temperature sensor measures the temperature of the machine bed and the cooling system is controlled according to the detected temperature values.

Such a thermal detection of changes in the machine bed is usually only possible, among other things, with a time delay due to the thermal inertia of the machine bed or, respectively, short-term changes can possibly not be detected. Also, such a thermal compensation of changes in the machine bed is generally only possible with a time delay.

It is the object of the present invention to provide an alternative or improved structural component for a machine tool and an alternative or improved method for producing such a structural component, respectively, with which, in particular, a detection as accurate as possible of a mechanical load acting on the structural component and/or a detection of a mechanical load is possible substantially in real time.

This object is achieved by a structural component according to claim 1, a machine tool according to claim 9, a production method according to claim 10 and the use of a structural component according to claim 14. Refinements of the invention are specified in each case in the subclaims. The methods can also be refined by the features of the devices set forth below or in the subclaims or, vice versa, each of the features of the devices and of the methods can also be used in combination with one another for refinement.

A structural component according to the invention is used for a machine tool. The structural component is formed from mineral casting, and at least one sensor module is integrated into the structural component. The sensor module is completely enclosed by the mineral casting and contains at least one sensor for detecting a mechanical load.

The structural component is preferably used for defined positioning of an object, i.e., a workpiece, to be machined with the machine tool, with respect to the machining device. Further preferably, a Tool Center Point (TCP) is associated with the machine tool and defines a spatial reference between the structural component or a workpiece arranged thereon or therein and a machine tool.

The fact that the sensor module is completely enclosed by the mineral casting preferably means that the mineral casting or the structural component surrounds the sensor module or at least the sensor or sensors thereof in a form-fitting manner and in all three spatial directions and is in contact with the sensor module or the sensor(s). As described further below, the sensor module is preferably molded in for this purpose during production of the structural component. Complete enclosure of the sensor module or the sensor(s) by the mineral casting does not exclude that parts of the sensor module or elements associated with the sensor module, for example a cable that serves as a data link for outputting the sensor values detected by the sensor module, protrude from the structural component.

The sensor module comprises at least one sensor, preferably a plurality of sensors, which are further preferably arranged in a defined position with respect to each other. In this context, a defined position with respect to each other means that the spatial position and spatial orientation of the sensors with respect to each other is fixed. In particular, the sensor module can comprise different sensors, thus sensors configured to detect different physical quantities.

The at least one sensor is preferably configured to detect an at least local mechanical load on the structural component, i.e., it responds directly to a mechanical load or stress acting on the structural component in the region of the sensor. Examples of mechanical loads that can be detected by the sensor are given below. The sensor thus differs in particular from thermal sensors which detect a temperature change or an absolute temperature of the structural component. The mechanical load detected by the sensor can be mechanical in nature, for example due to a weight force acting on the structural component or a vibration in the structural component, and/or can be thermal in nature, for example a thermally induced change in length. This makes it possible, for example, to detect an occurring mechanical load on the structural component substantially without time delay. This can further allow, for example, to create a structural model of the structural component that is as accurate as possible, in particular within a relatively short period of time, and/or to detect mechanical loads on the structural component during operation of the machining device substantially in real time, i.e. substantially without time delays, and/or as accurately as possible. In particular, compared to thermal measurements on or in the structural component, which are usually performed with a time delay due to the thermal inertia of the structural component, the detection of mechanical loads by the sensor module can have the advantage, for example, that a model of the structural component for numerical calculations can be created in a shorter time and/or that a more accurate model of the structural component can be created.

Overall, the structural component according to the invention can enable, for example, direct detection or measurement of mechanical changes in the structural component which can negatively influence the precision of the machine tool, without requiring knowledge of thermal properties of the structural component.

In general, a mineral casting is to be understood as a material consisting of at least one or more fillers and a matrix, in the case of mineral casting a plastic matrix. By using mineral casting as a material for the structural component, it is possible, for example, to provide a structural component that is inexpensive and/or can be produced in a simple manner. It is hereby also possible, for example, to attach the sensors or the sensor module in the structural component with great freedom, especially at particularly relevant points. In addition, by embedding the sensors, they can be protected, for example, against external influences over a long period of time, which can ensure a long service life for the sensors. With such sensors integrated into the structural component for detecting mechanical loads, it is possible, for example, to use the sensors throughout their service life, for example to optimize the structural component during its development phase and/or to detect any damage during transport of the structural component and/or to monitor and/or correct the operation of the machining device. The fact that the same sensors, i.e. the same technology, is used in all of these exemplary phases can have a particularly advantageous effect. For example, it is also possible to evaluate the construction of the structural component statically or dynamically as early as in the component stage and/or to precisely carry out the alignment and/or mounting of the structural component in the assembly process and/or to detect long-term changes in the structural component after the machining device has been put into operation or during the operation of the machining device.

Preferably, the at least one sensor is configured to detect a mechanical load both statically, i.e. continuously, and intermittently. This makes the sensor suitable for use, for example, in different measurements, which can reduce the overall number of sensors required. Alternatively or additionally, the at least one sensor is preferably configured to detect a mechanical load within a period of less than 1 ms after its occurrence in the structural component. This makes it possible, for example, to detect the mechanical load with the smallest possible time offset or substantially in real time.

Preferably, the sensor module or the at least one sensor is configured to detect a compressive force and/or a tensile force and/or an elongation and/or a compression and/or a bending and/or a torsion and/or a length change and/or a mechanical vibration. This makes it possible, for example, to provide various options for detecting a (local) mechanical load on the structural component, or to detect different mechanical loads.

Preferably, the sensor module or the at least one sensor is configured to detect mechanical loads as absolute value. This makes it possible, for example, to detect changes in the structural component even during interrupted measurements, i.e. not continuously, and in particular over a long period of time. In particular, it is thus possible, for example, to be able to detect long-term changes in the structural component which are caused, for example, by the operating loads and/or by the installation.

Preferably, the sensor module or the at least one sensor is configured to detect mechanical vibrations, the frequency of which corresponds at least to the lowest natural frequency of the structural component. This makes it possible, for example, to perform a modal analysis of the structural component, as described below.

Preferably, the sensor module further includes at least one temperature sensor that is located in a defined position or at a predetermined position with respect to the at least one sensor for detecting a mechanical load. This preferably means that the spatial position and spatial orientation of the sensors, i.e. the temperature sensor(s) and the sensor(s) for detecting a mechanical load, are fixed in relation to one another. This makes it possible, for example, to evaluate different measured values, which are detected by the different sensors, in their spatial relation to each other and thus to determine a structural model of the structural component that is as accurate as possible. By providing a temperature sensor it is also possible, for example, to consider thermal effects in the structural component separately or in connection with the mechanical loads that occur, in particular to create a thermo-mechanical model of the structural component.

Preferably, the sensor module is provided at a predetermined position in the structural component. This makes it possible, for example, to attach the sensor module at particularly relevant points in the structural component, for example where large mechanical loads occur. For example, the sensor module can be attached to or in the vicinity of a holding fixture, e.g. a linkage, which is integrated into the mineral casting and serves, e.g., to secure further elements of the machine tool.

Preferably, the structural component further comprises at least one actuator provided on the structural component or integrated in the structural component. Further preferably, the at least one actuator is configured to at least partially compensate for the mechanical load in the structural component detected by the at least one sensor, in particular a compressive force and/or a tensile force and/or an elongation and/or a compression and/or a bending and/or a torsion and/or a length change and/or a mechanical vibration. The actuator can compensate or reduce the occurring load, for example, mechanically, e.g. by counteracting the occurring force, and/or thermally.

Preferably, the structural component is a machine bed and/or the machining device is a machine tool. Alternatively, the structural component can be designed, for example, as a column, a gantry, a spindle suspension, a device body, or the like. Thus, for example, various structural components are provided in which the invention can advantageously be used.

A machining device according to the invention comprises a structural component described above. This makes it possible, for example, to achieve the effects described above with respect to the structural component in a machining device.

A method according to the invention is used for producing a structural component for a machine tool and comprises at least the following steps: Providing a casting mold for the structural component, providing at least one sensor module in and/or on the casting mold, wherein the sensor module contains at least one sensor for detecting a mechanical load, and introducing a liquid mineral casting into the casting mold. Thus, for example, a method for producing a structural component according to the invention can be provided which can be carried out in a simple manner and at low cost.

In the method, the sensor module is preferably provided at a predetermined position in and/or on the casting mold. This makes it possible, for example, to attach the sensor module at particularly relevant points in the structural component, for example where high mechanical loads occur.

Preferably, the casting mold is removed from the structural component after the mineral casting has cured. By removing the casting mold, it is possible, for example, to provide the structural component for use in the machining device.

Preferably, sensor values are detected during the method at least temporarily by the at least one sensor, and at least one optimization value for the structural component is determined based on the detected sensor values. The optimization value can be, for example, a weight and/or a material composition and/or a geometric shape and/or a dimensioning of the structural component. This makes it possible, for example, to detect inhomogeneities in the structural component as part of quality assurance, or to provide a structural component that is as homogeneous as possible and/or a structural component that is as optimally adapted as possible to an intended use.

According to the invention, when a structural component described above is used in a machine tool, sensor values are detected by the at least one sensor at least temporarily during and/or before and/or after operation of the machine tool. This makes it possible, for example, to detect each of the mechanical loads occurring in the structural component as precisely as possible in terms of location and time and, if necessary, to compensate for them or to intervene in the operation of the machine tool in a corrective manner.

Preferably, the detected sensor values are used to determine natural vibrations of the structural component and, at the same time, their effects at a Tool Center Point of the machine tool. The effect at the Tool Center Point is preferably determined by means of a further sensor provided, for example a vibration sensor, acceleration sensor etc. This makes it possible, for example, to perform a modal analysis of the structural component, and thus to determine effects of certain excitation frequencies on the Tool Center Point, in order to be able to compensate or prevent them, for example.

Further features and advantages of the invention will be apparent from the description of exemplary embodiments with reference to the accompanying drawings.

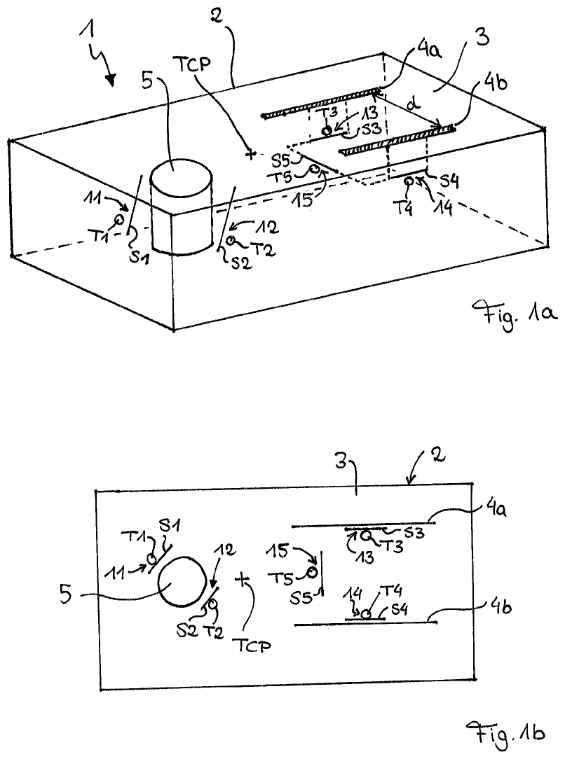

FIG. 1a is a schematic perspective view of a machine bed of a machine tool with integrated sensors according to one embodiment of the present invention, and FIG. 1b is a schematic illustration of an orthogonal projection of the sensors shown in FIG. 1a onto the upper side of the machine bed.

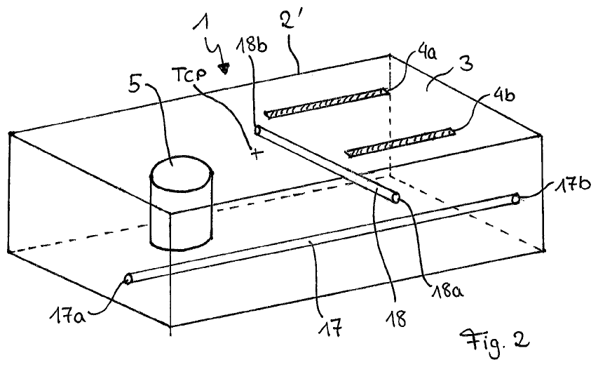

FIG. 2 is a schematic perspective view of the machine bed shown in FIG. 1a according to a refinement of the invention.

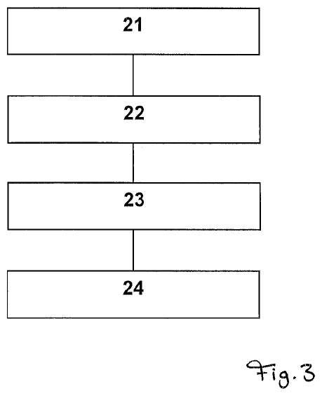

FIG. 3 shows schematically the steps of a method according to the invention for producing the machine bed shown in FIGS. 1a, 1b and 2.

In the following, an embodiment of the present invention is described with reference to FIGS. 1a, 1b. FIG. 1a shows a processing machine designed as a machine tool 1 with a structural element designed as a machine bed 2. The machine tool 1 is designed for machining and/or manufacturing a workpiece (not shown in the figures) by means of at least one tool (not shown in the figures), the workpiece being attached to or on the machine bed 2.

The machine bed 2 in FIG. 1a, purely as an example, is formed in a cuboidal manner and is made of mineral casting. The machine bed 2 has an upper side 3. On the upper side 3A, a first linear guide 4a and a second linear guide 4b are arranged parallel to each other at a distance d. A slide, which is not shown in more detail in the figures, can be attached to the linear guides 4a, 4b, on or to which slide the workpiece (not shown in the figures) can be secured. The slide (not shown) is provided to be movable along the linear guides 4a, 4b across the surface 3 of the machine bed 2.

Furthermore, a holding fixture 5 is provided in the machine bed 2, which is embedded in the mineral casting and projects upwardly above the upper side 3 of the machine bed 2. To simplify the illustration, FIG. 1a only shows the portion of the holding fixture 5 provided in the machine bed 2. The holding fixture 5 shown in FIG. 1a is shaped, purely as an example, in the form of a rod or tower and has a circular cross-section in the surface of the upper side 3. For example, the tool, which is not shown in the figures, for machining or manufacturing the workpiece (also not shown) can be secured on the holding fixture 5.

Furthermore, purely as an example, a Tool Center Point TCP is shown which is associated with the machine tool 1 and is located in FIGS. 1a and 1b on the upper side 3 of the machine bed 2. The Tool Center Point can also be provided at another location of the machine tool 1, in particular above the machine bed 2.

The machine bed 2 shown in FIG. 1a has, purely by way of example, five sensor modules 11, 12, 13, 14, 15 integrated in the machine bed, each of the sensor modules 11, 12, 13, 14, 15 being completely enclosed by the mineral casting, i.e., when viewing the machine bed 2, the sensor modules 11-15 are not visible from the outside. Each of the sensor modules 11, 12, 13, 14, 15 has a sensor configured as a strain sensor S1-S5 for detecting a mechanical load, and a temperature sensor T1-T5. The strain sensors S1-S5, for example, can comprise glass fibers integrated into the machine bed 2, the length of which is detected interferometrically. The strain sensor S1-S5 and the respective temperature sensor T1-T5 of each of the sensor modules 11-15 are in a defined position with respect to each other, i.e., have a predefined distance and a predefined orientation with respect to each other. Furthermore, each of the sensor modules 11-15 is provided at a predetermined position in the machine bed 2. As can be seen from FIG. 1a and the orthogonal projection of the sensor modules 11-15 onto the upper side 3 shown in FIG. 1b, the first and second sensor modules 11, 12 are each provided in the vicinity of the holding fixture 5, and the third, fourth and fifth sensor modules 13, 14, 15 are provided in the vicinity of the linear guides 4a, 4b. The strain sensors S3, S4 of the third and fourth sensor modules 13, 14 each extend substantially parallel to the linear guides 4a, 4b and can be provided substantially vertically below the respective linear guides 4a, 4b, as indicated by the dashed lines in FIG. 1a. In FIG. 1b, the strain sensors S3, S4 of the third and fourth sensor modules 13, 14 are arranged horizontally offset from the linear guides 4a, 4b. The strain sensor S5 of the fifth sensor module 15 extends substantially transverse to the linear guides 4a, 4b.

Optionally, the machine tool 1 comprises an evaluation unit, which is not shown in the figures, to which each sensor module 11-15 or each sensor T1-T5, S1-S5 is connected via a data link.

In the exemplary embodiment described above, five sensor modules 11-15 are integrated into the machine bed 2, each comprising a strain sensor S1-S5 and a temperature sensor T1-T5. The sensor modules 11-15 can also be provided at least partially without the temperature sensor and/or can comprise any other sensors for detecting a mechanical load, for example a sensor configured to detect a compressive force and/or a tensile force and/or an elongation and/or a compression and/or a bending and/or a torsion and/or a length change and/or a mechanical vibration, or a plurality of such sensors. The sensor modules can also be configured differently, i.e., they can include at least partially different sensors and/or more or less than five sensor modules can be provided.

According to a first refinement of the machine bed 2 shown in FIGS. 1a, 1b, at least one of the sensor modules 11-15 comprises at least one sensor S1-S5 which is configured to detect mechanical vibrations, the frequency of which corresponds at least to the lowest natural frequency of the machine bed 2.

FIG. 2 shows a second refinement of the machine bed 2 shown in FIGS. 1a, 1b, wherein for simplification of the illustration, the sensors S1-S5, T1-T5 of the sensor modules 11-15 shown in FIGS. 1a, 1b are not shown in FIG. 2. Two temperature control lines 17, 18 are integrated in the machine bed 2′, which have connections 17a, 17b, 18a, 18b for feeding and discharging a medium, for example water, which is used for cooling or heating (generally controlling the temperature) the machine bed 2′. Thus, the machine bed 2′ can be cooled or heated by feeding the medium through the temperature control lines 17, 18.

Alternatively or additionally to the temperature control lines 17, 18 shown in FIG. 2, the machine bed 2′ can have one or more further actuators (not shown), in particular actuators configured to at least partially compensate for or counteract mechanical loads detected by the sensors S1-S5 of the sensor modules 11-15. Preferably, the actuators are connected to a control unit (not shown) via which the actuators are controlled.

During operation of the machine tool 1, the workpiece not shown in the figures is attached to the slide (not shown) and machined and/or manufactured by the tool (not shown). In this case, sensor values can be detected by the sensors S1-S5, T1-T5 of the sensor modules 11-15 integrated in the machine bed 2, 2′ at least temporarily during and/or before and/or after operation of the machine tool. The sensor values are transmitted to the evaluation unit (not shown) and evaluated by the evaluation unit. Based on the detected and evaluated sensor values, for example, the actuator(s) can be controlled in such a manner that they at least partially compensate for or counteract the detected mechanical load and/or a detected heat input. Alternatively or additionally, it is possible, based on the detected and evaluated sensor values, to intervene in the operation of the machine tool 1 or to stop its operation.

Preferably, a modal analysis of the machine bed 2, 2′ is performed at least once. For this purpose, the machine bed 2, 2′ is subjected to vibrations by external excitation and the natural vibrations of the machine bed 2, 2′ are determined by means of the sensor values detected by the sensors S1-S5 of the sensor components 11-15. At the same time, the structural response of the machine bed 2, 2′ is determined at a reference point, for example at the Tool Center Point TCP, by means of another provided sensor (not shown in the figures), for example a vibration sensor, acceleration sensor, etc.

In the following, a method for producing the machine bed 2, 2′ shown in FIGS. 1a, 1b, 2 is described with reference to FIG. 3. In a first step 21, a casting mold (not shown in the figures) suitable for the machine bed 2, 2′ to be produced is provided. In a second step 22, the sensor modules 11-15 with the respective sensors S1-S5, T1-T5 are provided and attached in and/or to the casting mold. In doing so, the sensor modules 11-15 are positioned in such a manner that they are later located at the desired positions in the finished machine bed 2, 2′. Furthermore, in the second step 22, the holding fixture 5 is attached in and/or to the casting mold. If the machine bed is to be equipped with integrated actuators, for example the temperature control lines 17, 18 shown in FIG. 2, the actuators are also provided in the second step 22 and attached in and/or on the casting mold at the desired position.

Subsequently, in a third step 23, a liquid mineral casting is introduced into the casting mold. After the mineral casting has cured, the casting mold is removed from the machine bed 2, 2′ in a fourth step 24. In subsequent manufacturing and/or assembly steps (not shown in FIG. 3), the linear guides 4a, 4b can also be attached to the upper side 3 of the machine bed 2, 2′ and the machine bed 2, 2′ can be integrated into the machine tool 1 or further elements of the machine tool 1 can be attached to the machine bed 2, 2′.

During the production of the machine bed 2, 2′, for example for the purpose of quality control or process improvement, sensor values can be detected by the sensors S1-S5, T1-T5 at least temporarily, in particular during the curing or setting of the mineral casting. Based on the detected sensor values, at least one optimization value for the machine bed can be determined. The optimization value can be, for example, a weight and/or a material composition and/or a geometric shape and/or a dimensioning of the structural component.

Modifications of the machine tool described above are possible within the scope of the invention. Thus, the machine bed can also be provided without the holding fixture 5 described above with reference to FIGS. 1a, 1b, 2 and/or without the linear guides 4a, 4b. Alternatively or additionally, other structural elements can be provided on or embedded in the machine bed, in particular if the machine is a pick-and-place or packaging machine.

Although the present invention has been described with reference to a machine tool having a machine bed, it is not limited thereto. It can be applied to any machining devices having a structural component made of mineral casting. Preferably, the structural component of the machining devices is generally used for defined positioning of an object, i.e., a workpiece, to be machined with the machining device. As an alternative to the above-described design of the structural component as a machine bed, the structural component can be designed, for example, as a column, a gantry, a spindle suspension, a device body or the like.

1. A structural component for a machine tool (1), wherein the structural component (2, 2′) is formed from a mineral casting and at least one sensor module (11-15) is integrated into the structural component (2, 2′), wherein the sensor module (11-15) is completely enclosed by the mineral casting and contains at least one sensor for detecting a mechanical load (S1-S5) of the structural component during operation of the machine tool.

2. The structural component according to claim 1, wherein the sensor module (11-15) is configured to detect a compressive force and/or a tensile force and/or an elongation and/or a compression and/or a bending and/or a torsion and/or a length change and/or a mechanical vibration.

3. The structural component according to claim 1, wherein the sensor module (11-15) is configured to detect mechanical loads as absolute value.

4. The structural component according to claim 1, wherein the sensor module (11-15) is configured to detect mechanical vibrations, the frequency of which corresponds at least to the lowest natural frequency of the structural component (2, 2′).

5. The structural component according to claim 1, wherein the sensor module (11-15) contains at least one temperature sensor (T1-T5) which is located in a defined position with respect to the at least one sensor for detecting a mechanical load (S1-S5).

6. The structural component according to claim 1, wherein the sensor module (11-15) is provided at a predetermined position in the structural component (2, 2′).

7. The structural component according to claim 1, further comprising at least one actuator (17, 18) provided on the structural component (2′) or integrated in the structural component (2′).

8. The structural component according to claim 1, wherein the structural component is a machine bed.

9. A machine tool, comprising the structural component (2, 2′) according to claim 1.

10. A method for producing a structural component (2, 2′) for a machine tool (1), the method comprising at least the following steps:
Providing a casting mold for the structural component (2, 2′),
providing at least one sensor module (11-15) in and/or on the casting mold, wherein the sensor module (11-15) contains at least one sensor for detecting a mechanical load (S1-S5), and
introducing a liquid mineral casting into the casting mold.

11. The method according to claim 10, wherein the sensor module (11-15) is provided at a predetermined position in and/or on the casting mold.

12. The method according to claim 10, wherein the casting mold is removed from the structural component (2, 2′) after curing of the mineral casting.

13. The method according to claim 10, wherein during the method, sensor values are detected at least temporarily by the at least one sensor (S1-S5, T1-T5), and wherein at least one optimization value for the structural component (2, 2′) is calculated based on the detected sensor values.

14. A use of the structural component according to claim 1 in a machine tool (1), wherein during operation of the machine tool (1), sensor values are detected at least temporarily by the at least one sensor (S1-S5, T1-T5).

15. The use of the structural component according to claim 14, wherein natural vibrations of the structural component (2, 2′) and, at the same time, their effects are determined at a Tool Center Point (TCP) of the machine tool (1) by means of the detected sensor values.
